(19) United States
(12) Patent Application Publication
(10) Pub. No.: US 2012/0173674 A1
(43) Pub. Date: Jul. 5, 2012

(54) Multimedia Contents Processing Method And System

(75) Inventors: Junho Kim, Yongin-si (KR); Jungin Han, Hwaseong-si (KR)

(73) Assignee: SAMSUNG ELECTRONICS CO., LTD., Suwon-si (KR)

(21) Appl. No.: 13/242,519

(22) Filed: Sep. 23, 2011

(30) Foreign Application Priority Data
Dec. 30, 2010 (KR) 10-2010-0139473

(51) Int. Cl. G06F 15/16

(52) U.S. Cl. 709/219

(57) ABSTRACT

Embodiments provide a multimedia content processing method and a multimedia content processing system. The multimedia content processing method includes transmitting, by a mobile device, a request for a multimedia content file to a host device, and generating, by the host device, a pre-processed multimedia content file in response to the request. The generating step includes performing one or more pre-process operations on the multimedia content file such that the multimedia content file is modified. The method further includes downloading, by the mobile device, the pre-processed multimedia content file from the host device, and playing, by the mobile device, the pre-processed multimedia content file.

### CROSS-REFERENCE TO RELATED APPLICATIONS

This application claims the benefit, under 35 U.S.O §119, of Korean Patent Application No. 10-2010-0139473 filed Dec. 30, 2010, the entirety of which is incorporated by reference herein.

### BACKGROUND

1. Field

Embodiments relate to a multimedia contents processing method and a multimedia contents system.

2. Description of the Related Art

Mobile devices may include MP3 players, PDA (portable multimedia player) devices, cellular phones, smart phones, etc. Users may reproduce multimedia contents using the mobile devices regardless of location. In general, the multimedia contents replayed by the mobile devices may be provided from host devices such as personal computers, web servers, etc.

### SUMMARY

An object of the inventive concepts is directed to reduce power consumption of a mobile device replaying multimedia contents provided from a host device.

The embodiments of the inventive concepts include a multimedia content processing method of a system including a host device and a mobile device. With the multimedia content processing method, the mobile device transmits a request for a multimedia content file to the host device. The host device generates a pre-processed multimedia content file in response to the request by performing one or more pre-process operations on the multimedia content file such that the multimedia content file is modified. The mobile device downloads the pre-processed multimedia content file from the host device and plays the pre-processed multimedia content file.

In one embodiment, the pre-process operations include a decoding operation on a data bit stream of the multimedia content file. In this embodiment, the playing of the pre-processed multimedia content file includes bypassing the decoding operation on the data bit stream of the pre-processed multimedia content file.

In another embodiment, the pre-process operations include a converting operation on meta information of the multimedia content file.

In another embodiment, the pre-process operations include a parsing operation on the multimedia content file. In this embodiment, the pre-processed multimedia content file includes a first sub-file corresponding to meta information of the multimedia content file and a second sub-file corresponding to a data bit stream of the multimedia content file.

In another embodiment, the pre-process operations include a relocating operation on at least one component of the multimedia content file. The pre-processed multimedia content file may include meta information and a data bit stream, where the data bit stream is placed following the meta information. Also, the pre-processed multimedia content file may include meta information, a data bit stream, and a dummy stream, where the dummy stream is placed following the data bit stream and the meta information.

In another embodiment, the pre-process operations include an inverting operation for inverting a dummy stream in the multimedia content file.

In another embodiment, the pre-process operations include a removal operation for removing a dummy stream from the multimedia content file.

The embodiments of the inventive concepts include a multimedia content processing system that includes a host device and/or a mobile device. The host device is configured to generate a pre-processed multimedia content file. The host device includes a pre-processor configured to perform one or more pre-process operations on the multimedia content file such that the multimedia content file is modified. The mobile device configured to download and play the pre-processed multimedia content file.

In one embodiment, the pre-process operations include a decoding operation on a data bit stream of the multimedia content file.

In another embodiment, the pre-process operations include a converting operation on meta information of the multimedia content file.

In another embodiment, the pre-process operations include a parsing operation on the multimedia content file, and the pre-processed multimedia content file includes a first sub-file corresponding to meta information of the multimedia content file and a second sub-file corresponding to a data bit stream of the multimedia content file.

In another embodiment, the pre-process operations include a relocating operation on at least one component of the multimedia content file.

In another embodiment, the pre-process operations include an inverting operation for inverting a dummy stream in the multimedia content file or a removal operation for removing a dummy stream from the multimedia content file.

In another embodiment, the pre-processor is configured to perform the pre-process operation when the multimedia content file is requested from the mobile device.

Embodiments of the inventive concepts include a multimedia content processing method. The method includes receiving, by a host device, a request for a multimedia content file to the host device, and generating, by the host device, a pre-processed multimedia content file in response to the request. The generating step includes performing one or more pre-process operations on the multimedia content file such that the multimedia content file is modified. The method further includes transmitting, by the host device, the pre-processed multimedia content file to a mobile device.

In one embodiment, the pre-process operations include a decoding operation, and the pre-processed multimedia content file includes meta information and a decoded data bit stream.

In another embodiment, the pre-process operations include a converting operation on meta information of the multimedia content file, and the pre-processed multimedia content file includes meta information having a format different from a format of the meta information of the multimedia content file.

In another embodiment, the pre-process operations include a parsing operation on the multimedia content file, and the pre-processed multimedia content file includes a first sub-file corresponding to meta information of the multimedia content file and a second sub-file corresponding to a data bit stream of the multimedia content file.

In another embodiment, the pre-process operations include a relocating operation on at least one component of the multimedia content file, and the pre-processed multimedia content file includes at least one of meta information, a data bit stream and a dummy stream that is located in a different location than in the multimedia content file.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram of a multimedia contents processing system according to an embodiment of the inventive concepts.

FIG. 2 is a flow chart for describing a multimedia contents processing method according to an embodiment of the inventive concepts.

FIGS. 3 to 9 show multimedia content files before and after a pre-process operation according to the first to seventh embodiments of the inventive concepts.

### DETAILED DESCRIPTION

The inventive concepts are described more fully hereinafter with reference to the accompanying drawings, in which embodiments of the inventive concepts are shown. These inventive concepts may, however, be embodied in many different forms and should not be construed as limited to the embodiments set forth herein. Rather, these embodiments are provided so that this disclosure will be thorough and complete, and will fully convey the scope of the inventive concepts to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concepts.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concepts. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which the inventive concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

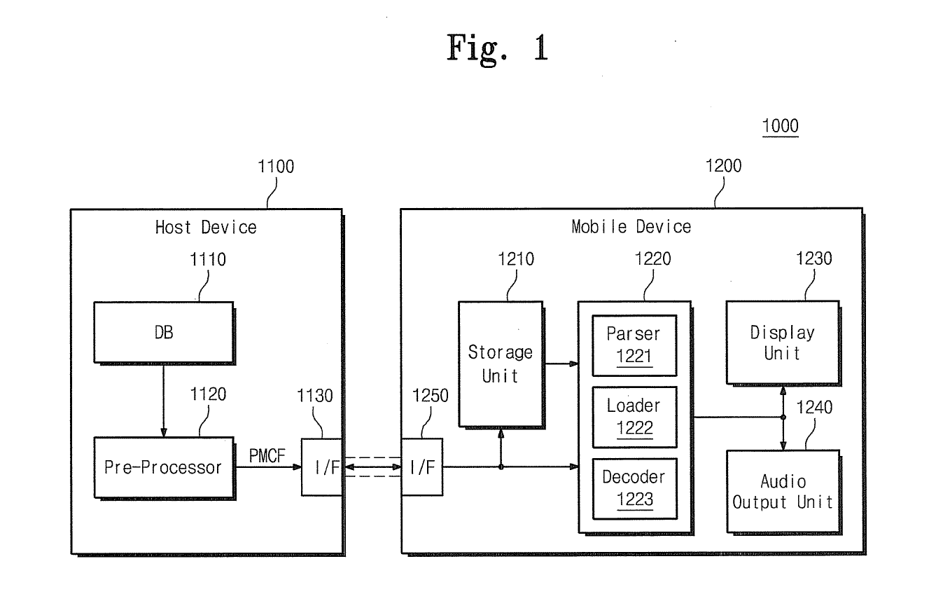

FIG. 1 is a block diagram of a multimedia contents processing system 1000 according to an embodiment of the inventive concepts.

Referring to FIG. 1, the multimedia contents processing system 1000 includes a host device 1100 and a mobile device 1200. The multimedia contents processing system 1000 may include other components that are well known to one of ordinary skill in the art. The mobile device 1200 may be configured to download and play back multimedia contents from the host device 1100. If a multimedia content file MCF is requested by the mobile device 1200, the host device 1100 may be configured to pre-process the multimedia content file MCF to obtain a pre-processed multimedia content file PMCF. Then, the host device 1100 may send the pre-processed multimedia content file PMCF to the mobile device 1200. That is, the multimedia content file PMCF pre-processed by the host device 1100 may be downloaded to the mobile device 1200. The mobile device 1200 may store and play the pre-processed multimedia content file PMCF.

The host device 1100 may be implemented by a personal computer, and/or a web server, for example. The host device 1100 may include a database (DB) 1110, a pre-processor 1120, and an interface 1130 for enabling communication with the mobile device 1200. However, the host device 1100 may include other components that are well known to one of ordinary skill in the art.

The database 1110 may store a plurality of multimedia content files MCFs. The multimedia content files MCFs stored in the database 1110 may have various formats of audio and/or video content files. For example, the database 1110 may store audio content files having formats such as MP3, AAC, OGG, WMA, ASF, and/or MP3pro, for example. Further, the database 1110 may include video content files having formats such as MP3, AVI, ASF, MPG, and/or MOV, for example.

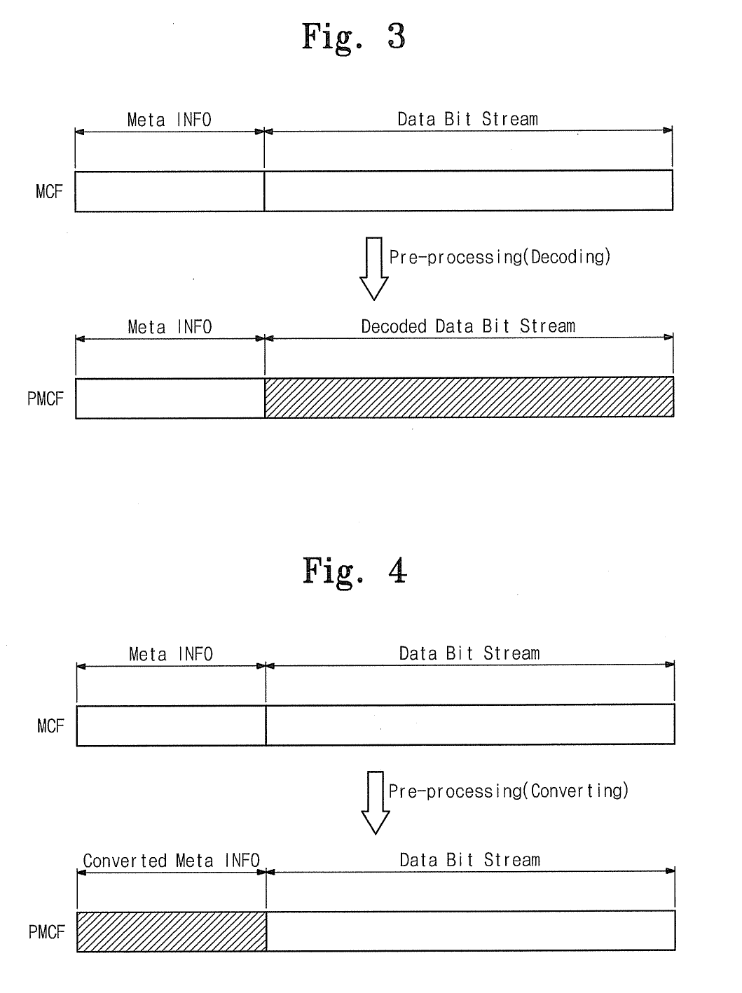

The pre-processor 1120 may be configured to pre-process the multimedia content file MCF provided from the database 1110 in order to obtain a pre-processed multimedia content file PMCF. For example, the pre-processor 1120 may perform one or more pre-process operations on the multimedia content file MCF such that the multimedia content file MCF is modified. The modified multimedia content file may be considered the pre-processed multimedia content file PMCF. The pre-processor 1120 may send the pre-processed multimedia content file PMCF to the mobile device 1200 via the interface 1130. Below, various embodiments of the pre-process operations of the pre-processor 1120 will be more fully described with reference to FIGS. 3 to 9.

The mobile device 1200 may include an MP3 player, a portable multimedia player (PMP), a cellular phone, or a smart phone, for example. The mobile device 1200 may include a storage unit 1210, a play unit 1220, a display unit 1230, an audio output unit 1240, and an interface 1250 for enabling communication with the host device 1100. However, the mobile device 1200 may include other components that are well known to one of ordinary skill in the art.

The storage unit 1210 may be configured to store the pre-processed multimedia content file PMCF transferred via the interface 1250. For example, the mobile device 1200 may download the pre-processed multimedia content file PMCF from the host device 1100 through the interface 1250. The mobile device 1200 may send the pre-processed multimedia content file PMCF stored in the storage unit 1210 to the play unit 1220, when the mobile device 1200 wishes to playback the media contents.

The play unit 1220 may be configured to replay the pre-processed multimedia content file PMCF transferred from the storage unit 1210. For example, the pre-processed multimedia content file PMCF is stored in the storage unit 1210 and then is replayed upon a request of a user. Alternatively, the play unit 1220 may play the pre-processed multimedia content file PMCF transferred from the interface 1250. For example, the pre-processed multimedia content file PMCF is played once the pre-processed multimedia content file PMCF is downloaded from the host device 1100 to the mobile device 1200.

The play unit 1220 may include a parser 1221, a loader 1222, and a decoder 1223. Although not illustrated in FIG. 1, the play unit 1220 may further include a post-processor which is configured to post-process data decoded by the decoder 1223. For example, the post-processor may perform a digital-to-analog converting operation. In addition, the play unit 1220 may include other components that are well known to one of ordinary skill in the art.

In general, a multimedia content file (pre-processed or not pre-processed) may include meta information and at least one data bit stream. The multimedia content file may further include a dummy stream. Below, components for replaying a multimedia content file will be more fully described.

The parser 1221 may parse a transferred multimedia content file. For example, the parser 1221 may divide the meta information, the data bit stream, and the dummy stream in the multimedia content file. The parser 1221 may obtain information (hereinafter, called play information) used to play the multimedia content file and information (hereinafter, called attribute information) indicating an attribute of the multimedia content file from the meta information. However, if a parsing operation is performed by the pre-processor 1120 with respect to the pre-processed multimedia content file PMCF, a workload of the parser 1221 may be reduced. This will be more fully described with reference to FIGS. 4 to 7.

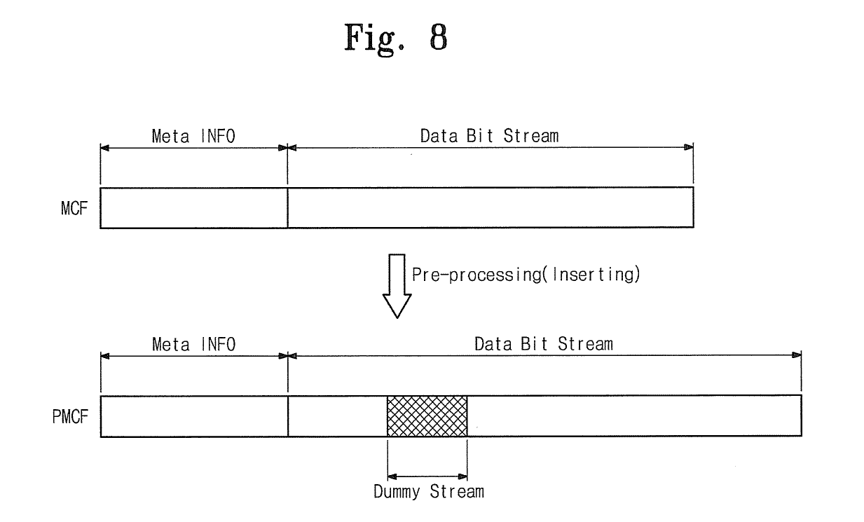

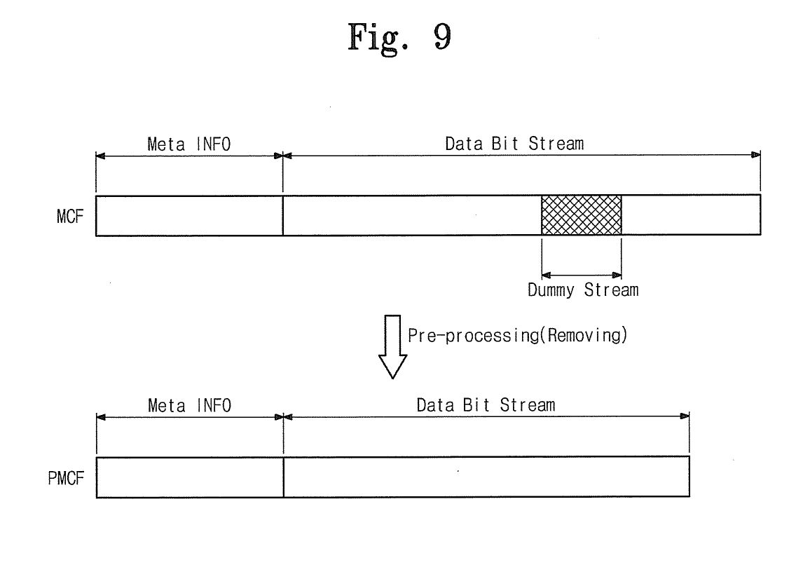

The loader 1222 may perform a buffering operation on the data bit stream based on the play information obtained from the meta information. That is, the loader 1222 may load the data bit stream onto an inner buffer memory according to a desired size (e.g., a size of a page) and transfer the loaded data having the desired size to the decoder 1223. For example, if the inner buffer memory is formed of a flash memory, the data bit stream may be loaded page-by-page. However, if a buffering operation is performed by the pre-processor 1120 with respect to the pre-processed multimedia content file PMCF, a workload of a buffering operation may be reduced. This will be more fully described with reference to FIGS. 8 and 9.

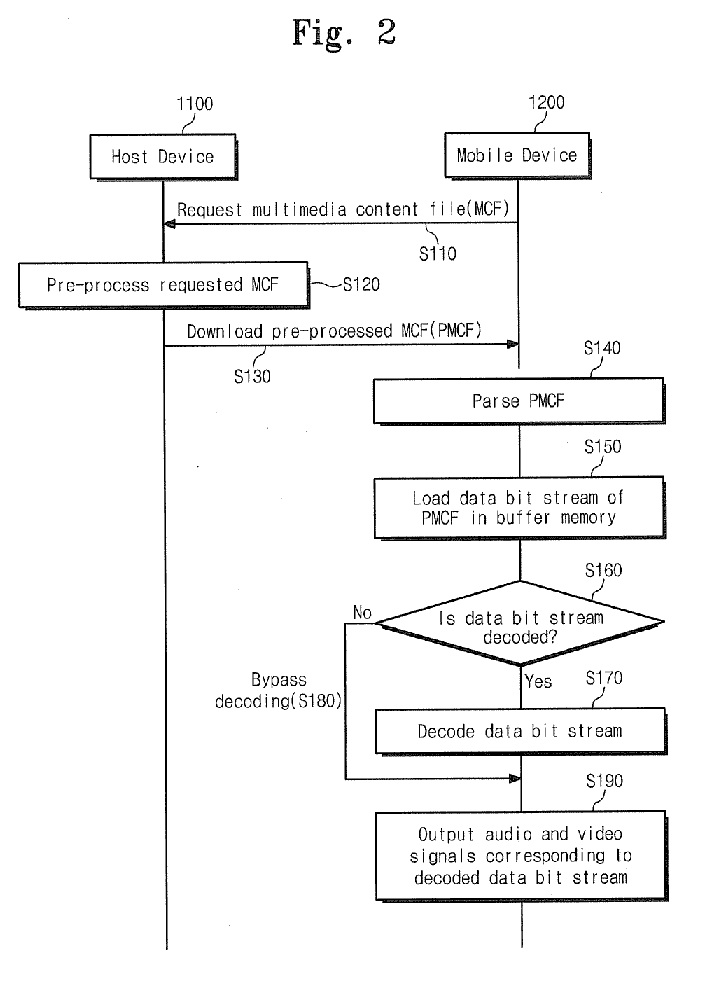

The decoder 1223 may perform a decoding operation on the data bit stream having the desired size, which is transferred from the loader 1222. After performing the decoding operation, the decoder 1223 may output the decoded data bit stream. The decoder 1223 may use a decoding operation corresponding to the format of a multimedia content file. If the pre-processed multimedia content file PMCF includes a decoded data bit stream, the decoder 1223 may bypass the decoding operation. In other words, if the pre-processor 1120 has already performed a decoding operation on the multimedia content file MCF, the decoder 1223 may bypass the decoding operation. This will be more fully described with reference to FIGS. 2 and 3.

The play unit 1220 may provide the display unit 1230 with a video output signal among output signals corresponding to the decoded data bit stream. Also, the play unit 1220 may provide the audio output unit 1240 with an audio output signal among the output signals corresponding to the decoded data bit stream. Further, the play unit 1220 may provide the display unit 1230 with attribute information corresponding to the pre-processed multimedia content file PMCF.

The display unit 1230 may display an image corresponding to the video output signal provided from the play unit 1220. The display unit 1230 may display the attribute information provided from the play unit 1220. The audio output unit 1240 may generate a sound in response to the audio output signal provided from the play unit 1220.

The interfaces 1130 and 1250 may support wire or wireless protocols. For example, the interfaces 1130 and 1250 may support a wire interconnection according to an USB (universal serial bus) protocol, for example. Also, the interfaces 1130 and 1250 may support wireless communication according to protocols such as a local area network (LAN), or Bluetooth, for example.

As described above, the host device 1100 may pre-process the multimedia content file MCF to generate the pre-processed multimedia content file PMCF, and the mobile device 1200 coupled to the host device 1100 may download, store and play the pre-processed multimedia content file PMCF.

FIG. 2 is a flow chart for describing the multimedia content processing method according to an embodiment of the inventive concepts. The multimedia content processing method may be performed by the multimedia contents processing system 1000 of FIG. 1.

In step S110, the mobile device 1200 may transmit a request for a multimedia content file MCF to the host device 1100. In step S120, the host device 1100 may pre-process the requested multimedia content file MCF to obtain a pre-processed multimedia content file PMCF. For example, the host device 1100 may perform one or more pre-process operations on the multimedia content file MCF such that the multimedia content file MCF is modified to a pre-processed multimedia content file PMCF. In step S130, the mobile device 1200 may download the pre-processed multimedia content file PMCF from the host device 1100.

Steps S140 to S190 may be performed by the mobile device 1200 to play the pre-processed multimedia content file PMCF. In step S140, the mobile device 1200 may perform a parsing operation on the pre-processed multimedia content file PMCF. In step S150, the mobile device 1200 may perform a buffering operation on the data bit stream of the pre-processed multimedia content file PMCF. The data bit stream may be loaded on a buffer memory according to the desired size through the buffering operation.

In step S160, the mobile device 1200 may determine whether the data bit stream of the pre-processed multimedia content file PMCF has been decoded. That is, the mobile device 1200 may determine whether the data bit stream has been previously decoded by a pre-process operation executed by the host device 1100. If the data bit stream has not been decoded, the method proceeds to step S170, in which the mobile device 1200 decodes the data bit stream. If the data bit stream has been decoded by the pre-process operation, the method proceeds to step S180, in which the decoding operation of the mobile device 1200 is bypassed.

In step S190, the mobile device 1200 may generate audio and video output signals corresponding to the decoded data bit stream. The steps S150 to S190 may be repeated until one multimedia content file is fully played.

FIGS. 3 to 9 show multimedia content files before and after a pre-process operation performed by the pre-processor 1120 of FIG. 1 according to the embodiments of the inventive concepts.

According to a first embodiment of the pre-process operation, FIG. 3 illustrates a decoding operation on the data bit stream. For example, the pre-processor 1120 may perform a decoding operation on the original multimedia content file MCF. In this case, if an original multimedia content file MCF is pre-processed, the pre-processor 1120 obtains a pre-process multimedia content file PMCF including meta information and a decoded data bit stream. For example, in one embodiment, the pre-processor 1120 may perform a pulse code modulation (PCM) operation on the data bit stream of the multimedia content file MCF. As such, the decoded data bit stream may be the PCM data bit stream. However, the embodiments encompass any type of decoding operation. If the pre-processed multimedia content file PMCF is played by the mobile device 1200, mobile device 1200 may bypass the decoding operation performed by the decoder 1223. As such, a workload of the mobile device 1200 may be reduced.

According to a second embodiment of the pre-process operation, FIG. 4 illustrates a converting operation on the meta information. If an original multimedia content file MCF is pre-processed, the pre-processor 1120 obtains a pre-processed multimedia content file PMCF including converted meta information and a data bit stream. For example, the converted meta information of the pre-processed multimedia content file PMCF may include an ID3 tag which has a version different from an ID3 tag included in the original meta information. In other words, the pre-processor 1120 may convert a format of the meta information of the multimedia content file MCF. In one embodiment, the converted format may be a simpler version of the original format. If the multimedia content file PMCF pre-processed according to the second embodiment is played by the mobile device 1200, the parser 121 performs a parsing operation on a simpler format of the meta information. Therefore, a workload of the parsing operation performed by the parser 1221 may be reduced. As such, a workload of the mobile device 1200 may be reduced.

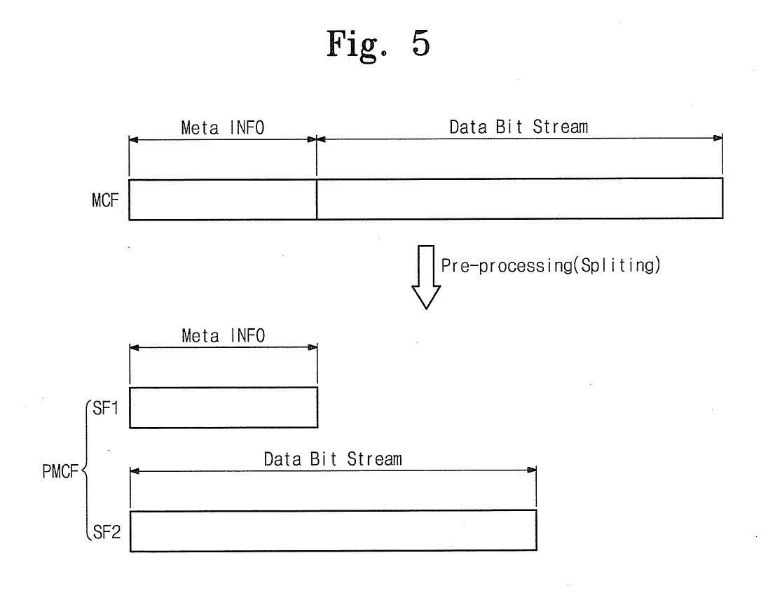

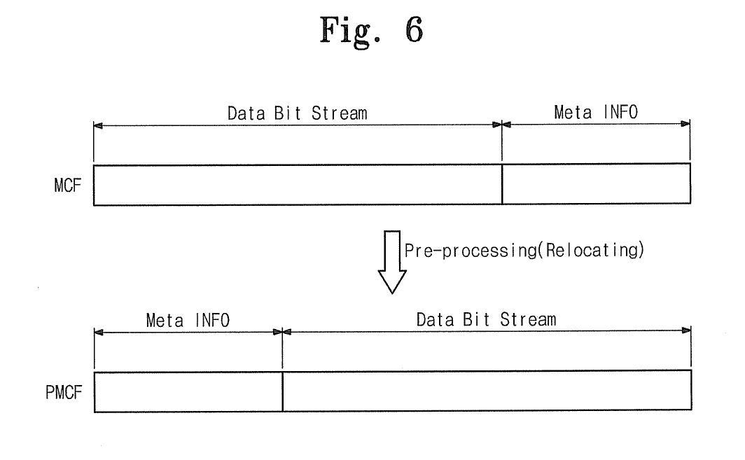

Referring to FIG. 5, the pre-process operation according to a third embodiment may include performing a split operation on an original multimedia content file MCF. If the pre-process operation on the original multimedia content file MCF is carried out, the original multimedia content file MCF may be split into first and second sub-files SF1 and SF2. Accordingly, the pre-processor 1120 obtains a pre-processed multimedia content file PMCF including the first and second sub-files SF1 and SF2. According to one embodiment, the first sub-file SF1 may correspond to the meta information, and the second sub-file SF2 may correspond to the data bit stream. If the multimedia content file PMCF pre-processed according to the third embodiment is played by the mobile device 1200, the parsing operation performed by the parser 1221 is reduced because the meta information and the data bit stream have already been divided. That is, a workload of the parsing operation may be reduced. As such, a workload of the mobile device 1200 may be reduced.

FIG. 6 illustrates an original multimedia content file MCF including meta information and a data bit stream. The meta information may be placed following the data bit stream. During the parsing operation, the parser 1221 accesses the data bit stream prior to the meta information.

In general, if the meta information is placed prior to the data bit stream, the parsing operation may be efficiently performed due to its characteristic. The pre-process operation according to a fourth embodiment may include performing a relocating operation on components of an original multimedia content file MCF such that the meta information is placed prior to the data bit stream. Thus, if the multimedia content file PMCF pre-processed according to the fourth embodiment is played by the mobile device 1200, the parsing operation may be performed efficiently. As such, a workload of the mobile device 1200 may be reduced during a playback operation.

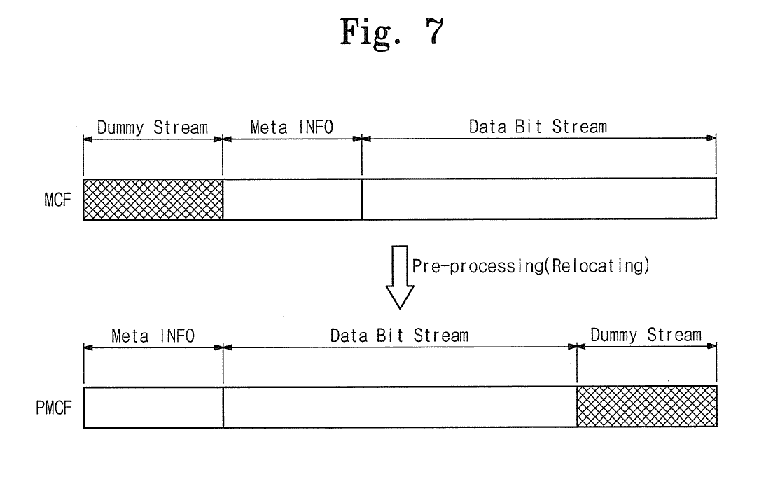

FIG. 7 illustrates an original multimedia content file MCF including meta information, a data bit stream, and a dummy stream according to an embodiment. The dummy stream may be placed prior to the meta information and the data bit stream. As such, during a parsing operation, the parser 1221 accesses the dummy stream prior to the meta information and the data bit stream.

In general, if the dummy stream is placed following the meta data and the data bit stream, the parsing operation may be efficiently performed due to its characteristic. The pre-process operation according to a fifth embodiment includes performing a relocating operation on components of an original multimedia content file MCF such that the dummy stream is placed following the meta information and the data bit stream. Thus, if the multimedia content file PMCF pre-processed according to the fifth embodiment is played by the mobile device 1200, the parsing operation may be performed efficiently. As such, a workload of the mobile device 1200 may be reduced during a playback operation.

Referring to FIG. 8, the pre-process operation according to a sixth embodiment may include performing an operation of inserting a dummy stream in an original multimedia content file MCF. If the multimedia content file PMCF pre-processed according to the sixth embodiment, the pre-processor 1120 may insert a dummy stream in the data bit stream. This operation may be carried out to adjust the length of the data bit stream such that a read number of valid data loaded in the buffer memory is reduced.

For example, if valid data having a size corresponding to one page is partially loaded on two pages of the buffer memory, a data read operation may be performed with respect to two pages to decode valid data, respectively. On the other hand, as described above, it is possible to align valid data by the page by adjusting the length of the bit stream through an insertion of a dummy stream. In this case, one read operation on a page of data may be performed to decode valid data.

If a multimedia content file PMCF pre-processed according to the sixth embodiment is played by the mobile device 1200, the number of read operations executed to read valid data loaded on the buffer memory may be reduced. Thus, a workload of the mobile device 1200 may be reduced.

Referring to FIG. 9, a pre-process operation according to a seventh embodiment may include performing an operation of removing a dummy stream from an original multimedia content file MCF. If the original multimedia content file MCF is pre-processed according to the pre-process operation of the seventh embodiment, the pre-processor 1120 may remove a dummy stream within a data bit stream. This operation may be carried out to adjust the length of the data bit stream such that the number of read operations executed to read valid data loaded on the buffer memory is reduced.

For example, if valid data having a size corresponding to one page is partially loaded on two pages of the buffer memory, a data read operation may be performed with respect to two pages to decode valid data, respectively. On the other hand, as described above, it is possible to align valid data by the page by removing the dummy stream to adjust the length of a bit stream. In this case, one read operation on a page of data may be performed to decode valid data.

If a multimedia content file PMCF pre-processed according to the seventh embodiment is played by the mobile device 1200, the number of read operations executed to read valid data loaded on the buffer memory may be reduced. Thus, a workload of the mobile device 1200 may be reduced.

The pre-process operation according to the seventh embodiment was described under the assumption that a dummy stream is removed. But, it is well understood that the embodiments are not limited thereto. For example, it is possible to a stream within a data bit stream other than audio and video streams.

As described above, the host device 1100 may pre-process multimedia contents. The host device 1100 may perform one or more of the above-described pre-process operations. For example, the host device 1100 may perform one pre-process operation (e.g., the decoding operation) or the host device 1100 may perform (sequentially or concurrently) any number of the above-described pre-process operations. Further, the host device 110 may include one or any number of pre-processors 1120 to execute the above-described pre-process operations. Thereafter, the mobile device 1200 may download, store and play the pre-processed multimedia contents. Accordingly, a workload required to play multimedia contents via the mobile device 1200 may be reduced. As a result, power consumption of the mobile device 1200 may be reduced.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

1. A multimedia content processing method of a system including a host device and a mobile device, the multimedia content processing method comprising:
transmitting, by the mobile device, a request for a multimedia content file to the host device;
generating, by the host device, a pre-processed multimedia content file in response to the request, the generating step including performing one or more pre-process operations on the multimedia content file such that the multimedia content file is modified;
downloading, by the mobile device, the pre-processed multimedia content file from the host device; and
playing, by the mobile device, the pre-processed multimedia content file.

2. The multimedia content processing method of claim 1, wherein the pre-process operations include a decoding operation on a data bit stream of the multimedia content file.

3. The multimedia content processing method of claim 2, wherein the playing step includes bypassing the decoding operation on the data bit stream.

4. The multimedia content processing method of claim 1, wherein the pre-process operations include a converting operation on meta information of the multimedia content file.

5. The multimedia content processing method of claim 1, wherein the pre-process operations include a parsing operation on the multimedia content file.

6. The multimedia content processing method of claim 5, wherein the pre-processed multimedia content file includes a first sub-file corresponding to meta information of the multimedia content file and a second sub-file corresponding to a data bit stream of the multimedia content file.

7. The multimedia content processing method of claim 1, wherein the pre-process operations include a relocating operation on at least one component of the multimedia content file.

8. The multimedia content processing method of claim 1, wherein the pre-process operations include an inverting operation for inverting a dummy stream in the multimedia content file.

9. The multimedia content processing method of claim 1, wherein the pre-process operations include a removal operation for removing a dummy stream from the multimedia content file.

10-15. (canceled)

16. A multimedia content processing method comprising:
receiving, by a host device, a request for a multimedia content file to the host device;
generating, by the host device, a pre-processed multimedia content file in response to the request, the generating step including performing one or more pre-process operations on the multimedia content file such that the multimedia content file is modified; and
transmitting, by the host device, the pre-processed multimedia content file to a mobile device.

17. The multimedia content processing method of claim 16, wherein the pre-process operations include a decoding operation, and the pre-processed multimedia content file includes meta information and a decoded data bit stream.

18. The multimedia content processing method of claim 16, wherein the pre-process operations include a converting operation on meta information of the multimedia content file, and the pre-processed multimedia content file includes meta information having a format different from a format of the meta information of the multimedia content file.

19. The multimedia content processing method of claim 16, wherein the pre-process operations include a parsing operation on the multimedia content file, and the pre-processed multimedia content file includes a first sub-file corresponding to meta information of the multimedia content file and a second sub-file corresponding to a data bit stream of the multimedia content file.

20. The multimedia content processing method of claim 16, wherein the pre-process operations include a relocating operation on at least one component of the multimedia content file, and the pre-processed multimedia content file includes at least one of meta information, a data bit stream and a dummy stream that is located in a different location than in the multimedia content file.
